(19) United States
(12) Patent Application Publication
(10) Pub. No.: US 2007/0217019 A1
(43) Pub. Date: Sep. 20, 2007

(54) OPTICAL COMPONENTS ARRAY DEVICE, MICROLENS ARRAY AND PROCESS OF FABRICATING THEREOF

(76) Inventors: Wen-Kuei Huang, Hsinchu City (TW); Chu-Jung Ko, Taipei City (TW); Fang-Chung Chen, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,311

(22) Filed: Mar. 16, 2006

(51) Int. Cl. G02B 3/00

(52) U.S. Cl. 359/642

(57) ABSTRACT

A process of fabricating a microlens array is provided. A self-assembled monolayer is formed on a substrate to form a hydrophilic region and a hydrophobic region. A liquid material is coated on the substrate so that a plurality of liquid microlenses is condensed on the hydrophilic region. The liquid microlenses are cured to form a plurality of microlenses.

### BACKGROUND OF THE INVENTION

1. Field of Invention

The present invention relates to an optical components array and a process of fabricating the same. More particularly, the present invention relates to a microlens array and a process of fabricating the same.

2. Description of Related Art

Recently, the application of the microlens has attracted great attention, as the microlens can significantly improve the performance of photoelectronic devices, especially in the fields of light-emitting devices, photo-detectors, solar cells, optical fiber communication, and micro-optical-electromechanical system, and so on. The prior art has proposed to fabricate a microlens array on the surface of the light-emitting diode, raising 50% the light-outcoupling efficiency. The prior art has proposed to fabricate a microlens array on the surface of the photo-detector enhancing 11% of the photocurrent. The microlens array can also be used in the solar cells of the satellite improving the light utilization of the solar cell. Therefore, we have to fabrication the microlens arrays economically and effectively.

There are many methods to fabricate microlenses, for example, ink-jet printing, photoresist reflow, molding, half tone mask lithography, and laser direct-writing, and so on. The ink-jet printing mainly uses the ink-jet head to press equivalent amount of liquid microlens material onto the substrate. Then, the liquid microlens material can be automatically condensed into hemispherical droplets under the surface tension and then cured to form microlenses on the surface of the substrate. The shape of the microlenses can be controlled by controlling the volume of the liquid microlens material and the surface property of the substrate. Moreover, the position of the microlenses can be precisely controlled by the ink-jet printing technology. However, the disadvantages of ink-jet printing are the high equipment cost and time-consumption.

The photoresist reflow method mainly employs spin-coating for controlling the film thickness of the photoresist, and a lithographic process for defining the shape and position of the photoresist, and then the photoresist is heated until the photoresist turns into a liquid state. At this time, the liquid photoresist is condensed into a hemispherical shape under the surface tension, and the liquid hemispherical photoresist solidifies at the room temperature. Then, a dry etching is carried out to pattern the photoresist into desired shape on the surface of the substrate. In the case of a fixed microlens base, the film thickness of the photoresist has a certain transformation relation with the shape of the microlens. However, the shortcoming of the photoresist reflow is the expensive lithographic equipment and the complicated fabricating process.

Molding mainly employs a micro-mechanical processing and diamond grinding to fabricate a recessed female mould of the microlens on the surface of the metal bulk material. Then, an injection molding or a mechanical pressing is used to define the shape of the microlens. However, the shortcoming of molding lies in the high manufacturing cost and it is difficult to miniaturize the microlens.

Half tone mask lithography mainly uses a half-tong mask to control the amount of the light flux, and adopts polymers as the microlens material. The ultraviolet light can break a polymer into smaller molecules by breaking bonds, and the smaller molecules can be dissolved in a developing solution such that the larger the amount of the light flux, the deeper the etching will be. The shortcoming of mask lithography lies in that the half-tong mask has a high manufacturing cost and the complicated fabricating process.

Laser direct-writing mainly employs an excimer laser to evaporate the substrate directly, so as to form the microlens shape. The shortcoming of laser direct-writing lies in that the equipment of the excimer laser is expensive and small particles remaining on the surface of the work piece adversely affect the optical properties of the microlens.

### SUMMARY OF THE INVENTION

In view of the above, an object of the invention is to provide a low cost process of fabricating a microlens array.

Furthermore, another object of the invention is to provide a microlens array to change the propagation direction of the light.

Additionally, still another object of the invention is to provide an optical components array device having improved performance.

In accordance with the above objectives and other objectives of the present invention, the invention provides a process of fabricating a microlens array. First, a self-assembled monolayer is formed on a substrate so as to form a hydrophilic region and a hydrophobic region. A liquid material is coated on the substrate so as to condense a plurality of liquid microlens on the hydrophilic region. And then, the liquid microlens are cured to form microlens.

In one embodiment of the invention, the region covered by the self-assembled monolayer is the hydrophobic region and the region exposed by the self-assembled monolayer is the hydrophilic region.

In one embodiment of the invention, the region covered by the self-assembled monolayer is a hydrophilic region and the region exposed by the self-assembled monolayer is a hydrophobic region.

In one embodiment of the invention, the process of forming the self-assembled monolayer includes forming an adhesive layer on a first mould; curing the adhesive layer to form a second mould; separating the first and the second moulds; and forming a self-assembled monolayer on the substrate through micro contact printing by a second mould.

In one embodiment of the invention, the adhesive layer can be polydimethylsiloxane (PDMS).

In one embodiment of the invention, the step of curing the liquid microlens employs ultraviolet irradiation or heat irradiation.

In accordance with the above objectives and other objectives of the present invention, the invention provides a microlens array arranged on a substrate. The microlens array includes a self-assembled monolayer and a plurality of microlenses, wherein the self-assembled monolayer is disposed on the substrate and defines a hydrophilic region and a hydrophobic region on the substrate. The microlenses are disposed on the hydrophilic region.

In one embodiment of the invention, the self-assembled monolayer can be a material having a general chemical structure X-R-Y, wherein X functional group is suitable for bonding with the substrate; R is a hydrocarbon chain; and Y functional group is suitable for changing the surface characteristic of the substrate.

In one embodiment of the invention, the X functional group can be symmetrical or non-symmetrical silane compounds, trichlorosilane, trimethoxysilane, disulfide, sulfide, diselenide, selenide, selenol, alkanethiol, nitrile, isonitrile, trivalent phosphorous compounds, isothiocyanate, xanthate, thiocarbamate, phosphine, thioacid, dithioacid, carboxylic acids, hydroxylic acids, or hydroxamic acids.

In one embodiment of the invention, the Y functional group can be hydroxy, carboxyl, amino, aldehyde, hydrazide, fluoro, phenyl, metallic compounds containing carbonyl, epoxy, or vinyl groups.

In one embodiment of the invention, the material of the microlens can be epoxy resin, acrylate, polysiloxane, polyimide, polyetherimide, perfluorocyclobutene, Benzoyclobutane (BCB), polycarbonate, polymethylmethacrylate (PMMA), polyurethane or PDMS.

In accordance with the above objectives and other objectives of the present invention, the invention provides an optical components array device including an optical components array device body and a microlens array. The microlens array is disposed on one surface of the optical components array device body. The microlens array includes a self-assembled monolayer and a plurality of microlens, wherein the self-assembled monolayer is disposed on the surface of the optical components array device body and defines a hydrophilic region and a hydrophobic region thereon. The microlens are disposed on the hydrophilic region.

In one embodiment of the invention, the self-assembled monolayer can be a material having a general chemical structure X-R-Y, wherein X functional group is suitable for bonding with the substrate; R is a hydrocarbon chain; and Y functional group is suitable for changing the surface characteristic of the substrate.

In one embodiment of the invention, the X functional group can be symmetrical or non-symmetrical silane compounds, trichlorosilane, trimethoxysilane, disulfide, sulfide, diselenide, selenide, selenol, alkanethiol, nitrile, isonitrile, trivalent phosphorous compounds, isothiocyanate, xanthate, thiocarbamate, phosphine, thioacid, dithioacid, carboxylic acids, hydroxylic acids, or hydroxamic acids.

In one embodiment of the invention, the Y functional group can be hydroxy, carboxyl, amino, aldehyde, hydrazide, fluoro, phenyl, metallic compounds containing carbonyl, epoxy, or vinyl groups.

In one embodiment of the invention, the material of the microlens can be epoxy resin, acrylate, polysiloxane, polyimide, polyetherimide, perfluorocyclobutene, Benzoyclobutane (BCB), polycarbonate, polymethylmethacrylate (PMMA), polyurethane or PDMS.

In one embodiment of the invention, the optical components array device body is a display, light-emitting diode, photodetector, or solar cell.

In view of the above, the invention adopts a self-assembled monolayer to change the surface property of the substrate, so as to form a hydrophilic region and a hydrophobic region. Thereafter, the liquid microlens are formed by condensing the liquid microlens material on the hydrophilic region under the surface tension. Therefore, it is possible to apply the process of the present invention in the mass production of the microlens array. The manufacturing cost of the microlens array can be effectively reduced.

In order to the make the aforementioned and other objects, features and advantages of the present invention comprehensible, a preferred embodiment accompanied with figures is described in detail below.

### BRIEF DESCRIPTION OF THE DRAWINGS

FIG. 1 is a flow chart of the process of fabricating a microlens array according to one embodiment of the invention.

FIGS. 2A to 2F are sectional views showing the steps of the process of fabricating the microlens array according to one embodiment of the invention.

FIG. 3A is a top view of an optical components array device according to one embodiment of the invention.

FIG. 3B depicts a sectional view along the line A-A′ of FIG. 3A.

### DESCRIPTION OF EMBODIMENTS

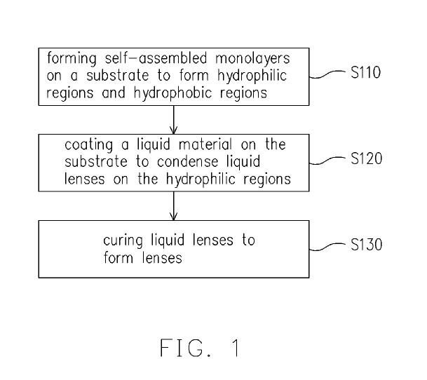

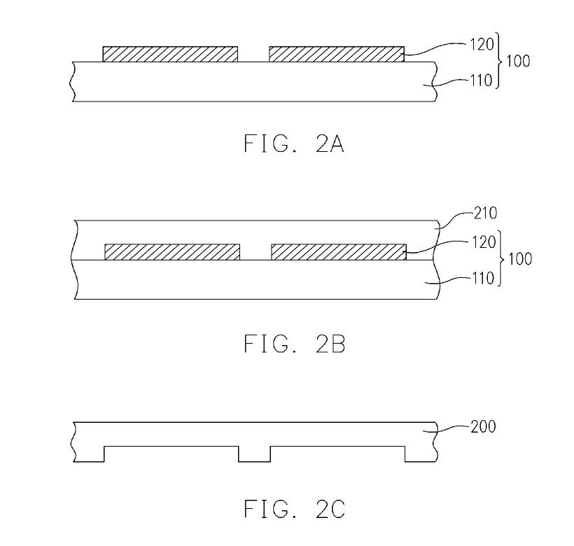

FIG. 1 is a flow chart of the process of fabricating the microlens array according to one embodiment of the invention. FIGS. 2A to 2G are sectional views showing the steps of the process of fabricating the microlens array according to one embodiment of the invention. Referring to FIG. 1, first, at Step S110, a self-assembled monolayer is formed on a substrate, so as to form a hydrophilic region and a hydrophobic region. Next, at Step S120, a liquid material is coated on the substrate, so as to condense multiple liquid microlens on the hydrophilic region. Next, a Step S130, the liquid microlens are cured so as to form a plurality of microlens

In the embodiment, the process of forming the self-assembled monolayer includes micro contact printing or other suitable methods.

Referring to FIG. 2A, in the micro contact printing, a first mould 100 having a substrate 110 and pillar structures 120 disposed thereon is provided. According to an embodiment of the present invention, the substrate 110 can be a silicon wafer. The substrate 110 may be patterned to form pillar structures 120 thereon, wherein the pillar structures 120 can be columns or prisms. However, it should be noted that the pillar structures 120 may also be formed by forming a material layer on the substrate 110 and then patterning the material layer to form pillar structures 120 on the substrate 110.

Referring to FIG. 2B, an adhesive layer 210 is formed on the first mould 100. The adhesive layer 210 can be PDMS. In particular, the adhesive layer 210 can be silicone elastomer 184 produced by Dow Corning Corporation, wherein the main ingredient (agent A) and the initiator (agent B) are mixed in a proportion of 10:1, and stirred for five to ten minutes until homogenous mixture obtained. Thereafter, the mixture allowed to stand still for about one hour so that foams generated during the stirring step disappear. Thereafter mixture is uniformly coated onto the surface of the first mould 100. For example, the thickness of the adhesive layer 210 can be about several millimeters.

Referring to FIG. 2C, the adhesive layer 210 is cured to form a second mould 200. And then the first mould 100 and the second mould 200 are separated. In particular, the adhesive layer 210 is baked by a heating lamp at a baking temperature of about 60˜80° C. for about one to two hours. After curing the adhesive layer 210, the first mould 100 and the second mould 200 are separated by mechanical means.

The second mold 200 comprised of, for example, PDMS after being cured is an elastomer with high mechanical strength and chemical stability, and forms into the desired shape provided in the first mould 100. Likewise, several second moulds 200 may be molded by the same first mould 100, and therefore fabrication cost can be effectively reduced.

Referring to FIG. 2D, the self-assembled monolayer material is uniformly coated on the surface of the second mould 200 to form a self-assembled monolayer 310. As the protrusion of the second mould 200 comprises tiny holes, the second mould 200 absorbs the self-assembled monolayer material through capillary action. Hereinafter, the components and process of fabricating the self-assembled monolayer 310 are illustrated in detail.

Preferably, the components of the self-assembled monolayer 310 are silane compounds or thiolene compounds diluted with organic solvents in a proper volume or molar concentration. The silane compounds and the thiolene compounds may readily react with the water and oxygen in the air, and therefore, the solution should be stirred in an environment free of water and or oxygen. The solvents used for diluting the silane or thiolene compounds should be of high-purity so that the property of the solution is not deteriorated.

In particular, the self-assembled monolayer 310 can be a material having a general chemical structure X-R-Y, wherein X functional group is suitable for bonding with the substrate; R is a hydrocarbon chain; and Y functional group is suitable for changing the surface characteristic of the substrate. R may be —(CH2)n-, wherein n is greater than or equal to 2.

The X functional group is comprised of symmetrical or non-symmetrical silane compounds, —SiCl3, —SiOCH3, —R′SSR, —RSSR, —R′SR, —RSR, —R′Se—SeR, R′SeR, —RSeR, selenol (—SeH), —RSH, —CN, isonitrile, trivalent phosphorous compounds, isothiocyanate, xanthate, thiolene compounds, phosphine, thioacid, dithioacid, carboxylic acids, hydroxylic acids, or hydroxamic acids. Moreover, the above-mentioned R and R′ are composed by hydrocarbon and have a long hydrocarbon chain structure including heterogeneous elements, such as N or F. Furthermore, it is desired that R and R′ do not have side chains to avoid irregular arrangement of the molecules.

The Y functional group is hydroxy, carboxyl, amino, aldehyde, hydrazide, fluoro, phenyl, metallic compounds containing carbonyl, epoxy, or vinyl groups.

Referring to FIG. 2E, the second mould 200 is used to form a self-assembled monolayer 310 on the substrate 410 by the micro contact printing. In an embodiment of the present invention, the substrate 410 comprises a thin metallic film, metal oxide, semiconductor materials or polymer materials. Examples of the thin metallic film include gold, silver, copper, aluminum, iron, nickel, zirconium, or platinum. Examples of semiconductor materials include silicon, silicon dioxide, glass, or quartz. Examples of polymer materials include cellulosic polymers such as polyethylene-terephthalate, acrylonitrile-butadiene-styrene, acrylonitrile-methyl acrylate copolymer, cellophane, thyl cellulose, cellulose acetate, cellulose acetate butyrate, cellulose propionate, cellulose triacetate; or polyethylene, polyethylene-vinyl acetate copolymers, ionomers (ethylene polymers), polyethylene-nylon copolymers, polypropylene, methyl pentene polymers, polyvinyl fluoride, and aromatic polysulfones.

The physical properties of the surface of the substrate 410, for example, hydrophilicity, hydrophobicity, and liquid contact angle, are can be modified by the covalent bonds between the self-assembled monolayer 310 and the substrate 410. Therefore, a hydrophilic region 410a and a hydrophobic region 310a can be defined on the substrate 410. In an embodiment of the present invention, as the surface property of the substrate 410 is hydrophilic and the surface property of the self-assembled monolayer 310 is hydrophobic so that when the self-assembled monolayer 310 is coated on the substrate 410, the region covered by the self-assembled monolayer 310 is the hydrophobic region 310a, and the region uncovered by the self-assembled monolayer 310 is the hydrophilic region 410a, as shown in FIG. 2E.

Referring to FIG. 2F, a liquid material is coated on the substrate 410, to condense multiple liquid microlenses on the hydrophilic region 410a. As the surface of the substrate 410 is defined into a hydrophobic region 310a and a hydrophilic region 410a, when a liquid material is coated on the substrate 410, the liquid material is condensed into multiple liquid microlens on the hydrophilic region 410a under the surface tension. In particular, the liquid microlens material has free flow characteristics, when the liquid material contacts the hydrophobic region 310a with a small surface energy, the liquid material flows toward the hydrophilic region 410a with a larger surface energy under repulsion. Moreover, the liquid material is condensed into hemispherical shape to form liquid microlens under the surface tension.

Thereafter, an ultraviolet radiation or thermal irradiation process is performed to cure the liquid microlens to form a plurality of microlens 320. The aforementioned microlens 320 is transparent and has a high mechanical strength, a high chemically stability, and can be easily fabricated by carrying out a comparatively simple process according to the present invention. Thus, on the cost of the microlens array can be effectively reduced. The refractive index of the microlens 320 is between 1 and 2. For example, the microlens 320 can be epoxy resin, acrylate, polysiloxane, polyimide, polyetherimide, perfluorocyclobutene, Benzoyclobutane (BCB), polycarbonate, polymethylmethacrylate (PMMA), polyurethane or PDMS.

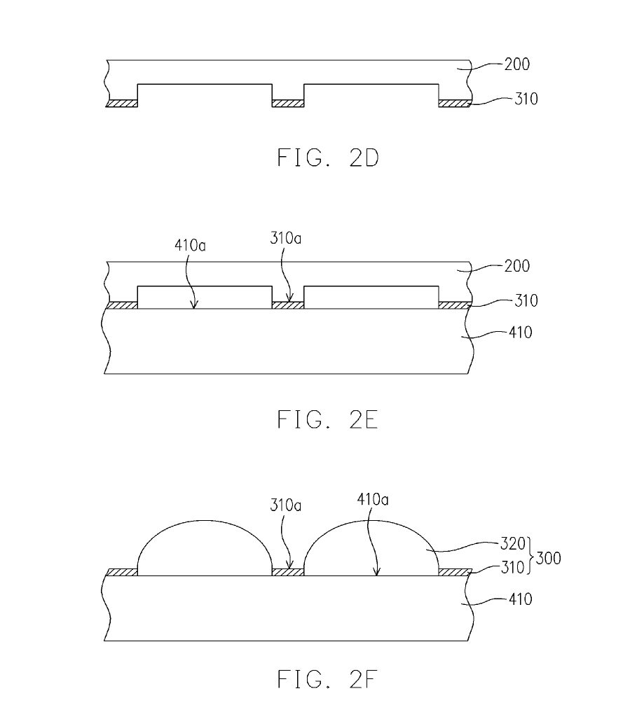

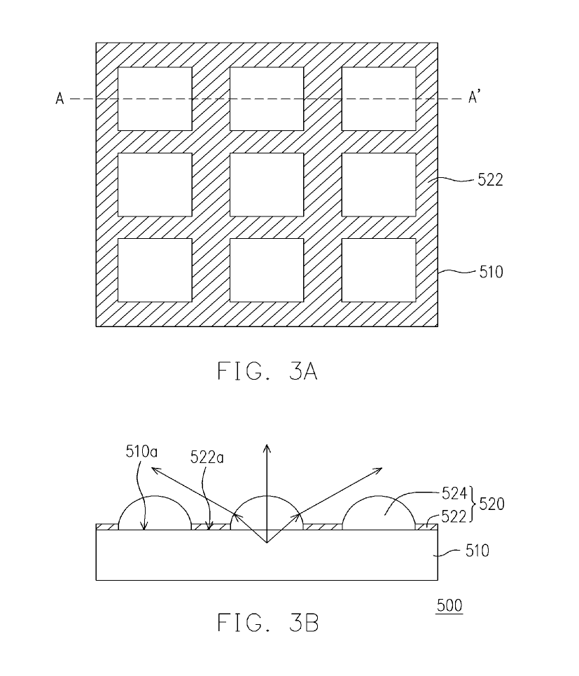

FIG. 3A is a top view of an optical components array device according to one embodiment of the invention, and FIG. 3B depicts a sectional view along the line A-A′ of FIG. 3A. Referring to FIGS. 3A and 3B, the optical components array device 500 includes an optical components array device body 510 and a microlens array 520. The optical components array device body 510 is, for example, a display, light-emitting diode, photodetector, or solar cell. Moreover, the microlens array 520 is disposed on a surface of the optical components array device body 510. The microlens array 520 includes a self-assembled monolayer 522 and a plurality of microlens 524, wherein the self-assembled monolayer 522 is disposed on the surface of the optical components array device body 510 and defines a hydrophilic region 510a and a hydrophobic region 522a thereon. Besides, the microlens 524 are disposed on the hydrophilic region 510a.

In an embodiment of the present invention, surface treatments such as UV ozone or O₂ plasma can be used to get a hydrophilic surface, when the surface of the optical components array device body 510 is hydrophobic. For example, when the surface of the optical components array device body 510 is hydrophobic and the surface of the self-assembled monolayer 522 is hydrophilic, the region covered by the self-assembled monolayer 522 is the hydrophilic region 522a, and the region uncovered by the self-assembled monolayer 522 is the hydrophobic region 510a.

It should be noted that the process of fabricating microlens arrays described above is not only applied to fabricate microlens arrays on the display, light-emitting diode, photodetector, or solar cell, but it can be also applied to fabricate microlens arrays on the surface of various optical components array devices.

For light-emitting diodes, the microlens array can not only reduce the probability of total internal reflection but also break the waveguide structure and microcavity effect to improve the light-emitting efficiency.

For photodetectors, the microlens array can focus the signals light into the photosensitive region, thereby improving the utilization of the light, the signal to noise ratio of the photodetector, and also improving the response time, thereby reducing distortion.

For solar cells, the microlens array can increase the environmental light absorption efficiency. Moreover, as the fabrication cost of the solar cell is very expensive, adding a microlens array on the surface of the solar cell can effectively reduce the size of the element.

In summary, the process of fabricating the microlens array according to the present invention can be used in optical components array devices, such as light-emitting diode, photodetector and solar cell, to improve the photoelectric efficiency. Furthermore, expensive machines and complex processes are required in the process of fabricating the microlens array described above. Therefore, the process of the present invention can be advantageously applied for industrial mass production of microlens arrays at substantially lower cost.

Though the present invention has been disclosed above by the preferred embodiments, it is not intended to limit the invention. Anybody skilled in the art can make some modifications and variations without departing from the spirit and scope of the invention. Therefore, the protecting range of the invention falls in the appended claims.

What is claimed is:

1. A process of fabricating a microlens array, comprising:
forming a self-assembled monolayer on a substrate to form a hydrophilic region and a hydrophobic region;
coating a liquid material on the substrate, wherein the coated liquid material condenses to form a plurality of liquid microlenses on the hydrophilic region; and
curing the liquid microlenses to form a plurality of microlenses.

2. The process of fabricating a microlens array according to claim 1, wherein the region covered by the self-assembled monolayer is the hydrophobic region, and the region not covered by the self-assembled monolayer is the hydrophilic region.

3. The process of fabricating a microlens array according to claim 1, wherein the region covered by the self-assembled monolayer is the hydrophilic region, and the region not covered by the self-assembled monolayer is the hydrophobic region.

4. The process of fabricating a microlens array according to claim 1, wherein the process of forming the self-assembled monolayer comprises:
forming an adhesive layer on a first mould;
curing the adhesive layer to form a second mould;
separating the first mould from the second mould; and
using the second mould to form the self-assembled monolayer on the substrate through a micro contact printing.

5. The fabrication method of a microlens array according to claim 4, wherein the adhesive layer comprises PDMS.

6. The fabrication method of a microlens array according to claim 1, wherein the step of curing the liquid microlenses includes utilizing ultraviolet irradiation or thermal irradiation.

7. A microlens array, adapted to be disposed on a substrate, the microlens array comprising:
a self-assembled monolayer, disposed on the substrate, wherein the self-assembled monolayer defines a hydrophilic region and a hydrophobic region on the substrate; and
a plurality of microlenses, disposed on the hydrophilic region.

8. The microlens array according to claim 7, wherein the self-assembled monolayer comprises a material having a general chemical structure X-R-Y, wherein X functional group promotes bonding with the substrate; R is a hydrocarbon chain; and Y functional group promotes changing of a surface characteristic of the substrate.

9. The microlens array according to claim 8, wherein the X functional group comprises symmetrical or non-symmetrical silane compounds including trichlorosilane, trimethoxysilane, disulfide, sulfide, diselenide, selenide, selenol, alkanethiol, nitrile, isonitrile, trivalent phosphorous compounds, isothiocyanate, xanthate, thiocarbamate, phosphine, thioacid, dithioacid, carboxylic acids, hydroxylic acids, or hydroxamic acids.

10. The microlens array according to claim 8, wherein the Y functional group comprises hydroxy, carboxyl, amino, aldehyde, hydrazide, fluoro, phenyl, metallic compounds containing carbonyl, epoxy, or vinyl groups.

11. The microlens array according to claim 7, wherein the microlenses comprise epoxy resin, acrylate, polysiloxane, polyimide, polyetherimide, perfluorocyclobutene, Benzoyclobutane (BCB), polycarbonate, polymethylmethacrylate (PMMA), polyurethane or PDMS.

12. An optical components array device, comprising:
an optical components array device body;
a microlens array, disposed on a surface of the optical components array device body, wherein the microlens array comprises:
a self-assembled monolayer, disposed on the surface of the optical components array device body, and defining a hydrophilic region and a hydrophobic region on the surface; and
a plurality of microlenses, disposed on the hydrophilic region.

13. The optical components array device according to claim 12, wherein the self-assembled monolayer comprises a material having a general chemical structure X-R-Y, wherein X functional group promotes bonding with the substrate; R is a hydrocarbon chain; and Y functional group promotes changing a surface characteristic of the substrate.

14. The optical components array device according to claim 13, wherein the X functional group comprises symmetrical or non-symmetrical silane compounds including trichlorosilane, trimethoxysilane, disulfide, sulfide, diselenide, selenide, selenol, alkanethiol, nitrile, isonitrile, trivalent phosphorous compounds, isothiocyanate, xanthate, thiocarbamate, phosphine, thioacid, dithioacid, carboxylic acids, hydroxylic acids or hydroxamic acids.

15. The optical components array device according to claim 13, wherein the Y functional group comprises hydroxy, carboxyl, amino, aldehyde, hydrazide, fluoro, phenyl, metallic compounds containing carbonyl, epoxy or vinyl groups.

16. The optical components array device according to claim 12, wherein the material of the microlenses comprises epoxy resin, acrylate, polysiloxane, polyimide, polyetherimide, perfluorocyclobutene, Benzoyclobutane (BCB), polycarbonate, polymethylmethacrylate (PMMA), polyurethane or PDMS.

17. The optical components array device according to claim 12, wherein the optical components array device body comprises one of a display, light-emitting diode, photodetector and solar cell.
